(19) United States
(12) Patent Application Publication
(10) Pub. No.: US 2018/0080407 A1
(43) Pub. Date: Mar. 22, 2018

(54) PISTON OF INTERNAL COMBUSTION ENGINE

(71) Applicant: SUBARU CORPORATION, Tokyo (JP)

(72) Inventor: Takayuki NAKAJI, Tokyo (JP)

(73) Assignee: SUBARU CORPORATION, Tokyo (JP)

(21) Appl. No.: 15/622,621

(22) Filed: Jun. 14, 2017

(30) Foreign Application Priority Data
Sep. 16, 2016 (JP) 2016-181372

(51) Int. Cl. F02F 3/26; F02F 3/28

(52) U.S. Cl. CPC F02F 3/26; F02F 3/28

(57) ABSTRACT

A piston of an internal combustion engine includes a crown surface, a first cavity, and a second cavity. The crown surface forms an internal wall surface of a combustion chamber. The first cavity is a depression provided in the crown surface. The second cavity is a depression provided inside the first cavity. The first cavity includes an upstream portion located upstream of the second cavity in a flow direction of a tumble flow flowing along the crown surface and a downstream portion located downstream of the second cavity in the flow direction. The upstream portion extends further in the flow direction than the downstream portion.

### CROSS-REFERENCE TO RELATED APPLICATIONS

The present application claims priority from Japanese Patent Application No. 2016-181372 filed on Sep. 16, 2016, the entire contents of which are hereby incorporated by reference.

### BACKGROUND

### 1. Technical Field

The present invention relates to a piston of an internal combustion engine whose crown surface has a cavity.

### 2. Related Art

Pistons whose crown surfaces have cavities have been proposed. For instance, Japanese Unexamined Patent Application Publication (JP-A) No. 2008-157197 discloses a technology in which a crown surface of a piston is provided with two cavities and the two cavities are selectively utilized, that is, an injector is directed to one of the cavities during full-load operation and directed to the other cavity during cold start.

JP-A No. 2009-46985 discloses a technology in which a crown surface of a piston has a cavity that follows a tumble flow and an interior of the cavity is provided with a damper portion that reduces the tumble strength of tumble flow partially so that the tumble strength is made uniform.

An engine operates in a stratified lean burn mode under a low load condition and in a homogeneous combustion mode under an increased load condition. In order to realize the stratified lean burn mode, a cavity that guides sprayed fuel to an ignition plug is provided as described in JP-A No. 2008-157197. In order to realize the homogeneous combustion mode, a cavity is provided so as to follow tumble flow as described in JP-A No. 2009-46985.

When part of tumble flow of sprayed fuel enters, of two cavities provided in the foregoing manner, the cavity formed to guide sprayed fuel to the ignition plug, the incoming tumble flow reduces a flow speed, resulting in a non-uniform flow speed of the tumble flow and therefore degraded quality of the tumble flow.

### SUMMARY OF THE INVENTION

It is desirable to provide an internal combustion engine piston that makes it possible to inhibit the deterioration of quality of tumble flow resulting from a non-uniform flow speed caused by crown cavities that guide fuel to an ignition plug.

A first aspect of the present invention provides a piston of an internal combustion engine that includes a crown surface configured to form an internal wall surface of a combustion chamber, a first cavity that is a depression provided in the crown surface, and a second cavity that is a depression provided inside the first cavity. The first cavity includes an upstream portion located upstream of the second cavity in a flow direction of a tumble flow flowing along the crown surface and a downstream portion of the first cavity located downstream of the second cavity in the flow direction. The upstream portion extends further in the flow direction than the downstream portion.

The second cavity may have an elliptical shape whose short axis lies in the flow direction.

A second aspect of the invention provides a piston of an internal combustion engine which includes a crown surface configured to face a combustion chamber, a first cavity that is a depression provided in the crown surface, and a second cavity that is a depression provided in the first cavity and that has an elliptical shape whose short axis lies in a flow direction of a tumble flow flowing along the crown surface.

### BRIEF DESCRIPTION OF THE DRAWINGS

FIG. 1 is a schematic illustrative diagram of an engine (internal combustion engine).

FIG. 2 is a perspective view of a crown surface side of a piston.

FIGS. 3A and 3B are diagrams for describing functions of a first cavity and a second cavity.

FIG. 4 is a front view of a crown surface of the piston.

FIGS. 5A and 5B are diagrams for describing a function resulting from the length of an upstream portion.

FIG. 6 is a perspective view of the crown surface side of a piston according to a modification.

FIG. 7 is a front view of the crown surface of the piston according to the modification.

### DETAILED DESCRIPTION

Preferred examples of the present invention will be described hereinafter with reference to the accompanying drawings. Dimensions, materials, other concrete numerical values, and the like indicated in conjunction with examples of the invention are merely illustrative for the purpose of facilitating the understanding of the invention and are not intended to limit the invention unless otherwise specified. In this specification and the accompanying drawings, elements that have substantially the same functions and configurations are referred to using the same characters and are not redundantly described and, furthermore, elements not directly relevant to the invention are omitted from the drawings.

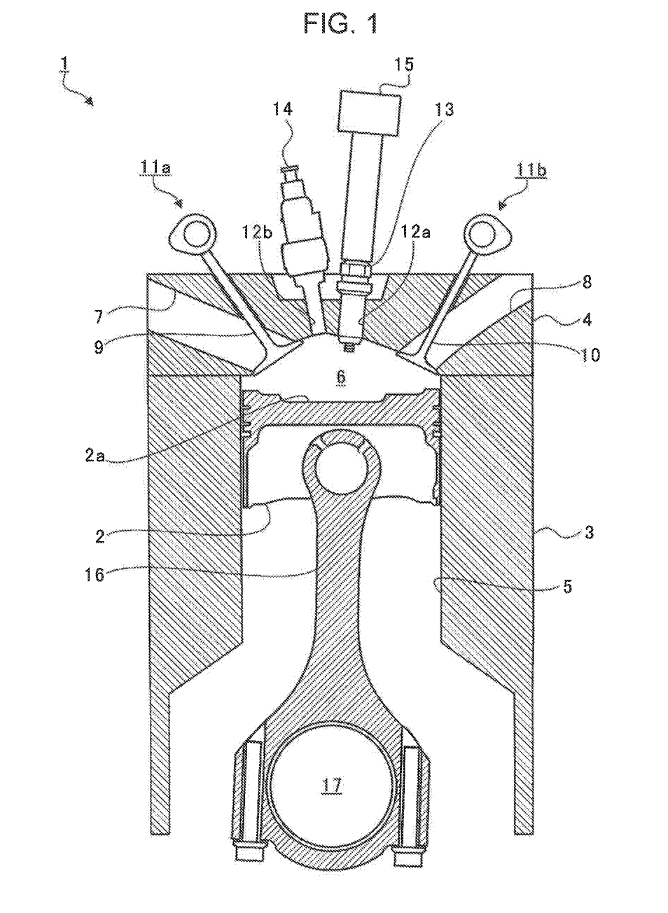

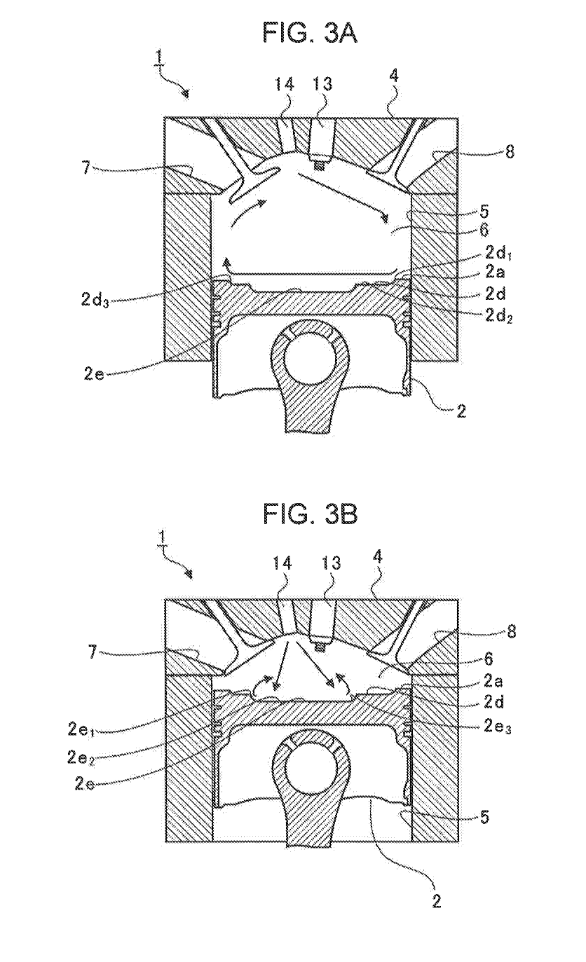

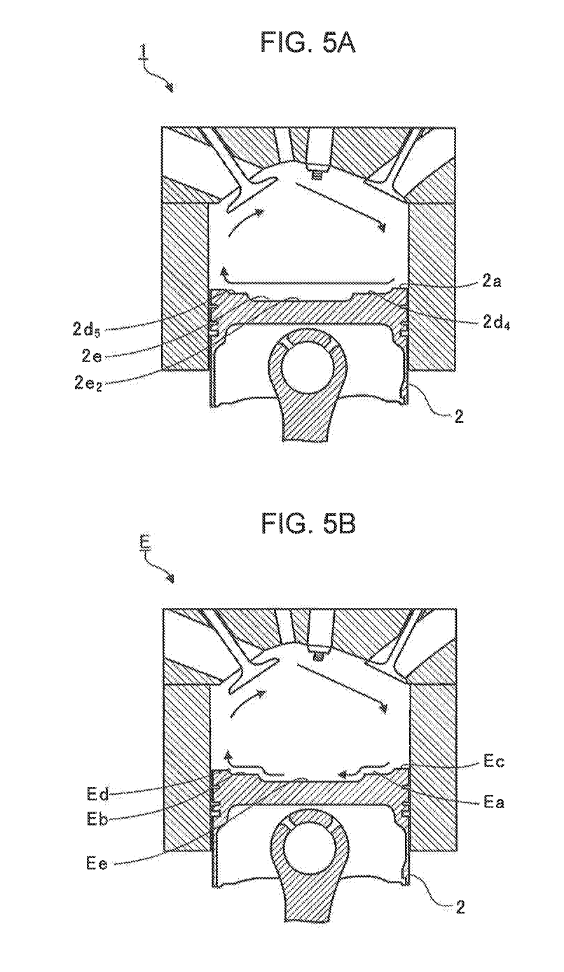

FIG. 1 schematically illustrates an engine 1 (internal combustion engine) in a schematic sectional view taken along a center axis of a piston 2 of the engine 1. FIG. 1 as well as FIGS. 3A and 3B and FIGS. 5A and 5B described later illustrate an intake port 7 and an exhaust port 8, which will be described later, for the sake of easy understanding. However, actual configurations are not necessarily the same as illustrated. For instance, an intake port 7 and an exhaust port 8 are provided at each one of the near and far sides of the plane of the section indicated in each of FIGS. 1, 3A, 3B, 5A, and 5B. The engine 1 is a four-stroke engine that undergoes cycles of an intake stroke, a compression stroke, a combustion stroke, and an exhaust stroke and includes a cylinder block 3, a cylinder head 4, and the piston 2 as illustrated in FIG. 1.

The cylinder block 3 has a cylinder 5 in which the piston 2 is freely slidably housed. The cylinder block 3 may have one or more than one cylinder 5.

The cylinder head 4 is coupled to a surface of the cylinder block 3 which includes an end of the cylinder 5. In the engine 1, a space defined by the cylinder 5 formed in the cylinder block 3, a crown surface 2a of the piston 2, and the cylinder head 4 forms a combustion chamber 6. That is, the crown surface 2a of the piston 2 forms a portion of an internal wall surface of the combustion chamber 6.

The cylinder head 4 has one or more than one two) of each of an intake port 7 and an exhaust port 8 that communicate with the combustion chamber 6. The cylinder head 4 is also provided with an intake valve 9 and an exhaust valve 10.

The intake valve 9 is disposed in the cylinder head 4 so that a distal end of the intake valve 9 is positioned between the intake port 7 and the combustion chamber 6. The intake valve 9 is moved by a cam mechanism 11a so that the intake port 7 communicates with and is closed to the combustion chamber 6. The exhaust valve 10 is disposed in the cylinder head 4 so that a distal end of the exhaust valve 10 is positioned between the exhaust port 8 and the combustion chamber 6. The exhaust valve 10 is moved by a cam mechanism 11b so that the exhaust port 8 communicates with and is closed to the combustion chamber 6.

The cylinder block 3 houses an ignition plug 13 and an injector 14. The cylinder block 3 has, at different positions, communicating portions 12a and 12b that are holes that communicate with the combustion chamber 6. A distal end of the ignition plug 13 is inserted into the communicating portion 12a. A distal end of the injector 14 is inserted into the communicating portion 12b. The distal end of the injector 14 is positioned in the vicinity of a center of the combustion chamber 6 (so-called center injection).

A coil device 15 is attached to a rear end of the ignition plug 13 (an opposite end thereof to the combustion chamber 6). The coil device 15 houses a primary coil and a secondary coil. As the magnetic field produced by the primary coil changes according to changes in the electric power supplied thereto from a battery or the like, an electromotive force is induced in the secondary coil. The electromotive force induced in the secondary coil is delivered to the ignition plug 13, so that the ignition plug 13 produces a spark discharge.

In the engine 1, after the injector 14 injects fuel at a predetermined timing, the fuel is ignited by the ignition plug 13. Such combustion causes the piston 2 to move back and forth in the cylinder 5, and the back-and-forth motion of the piston 2 is converted into rotational motion of a crankshaft 17 via a connecting rod 16.

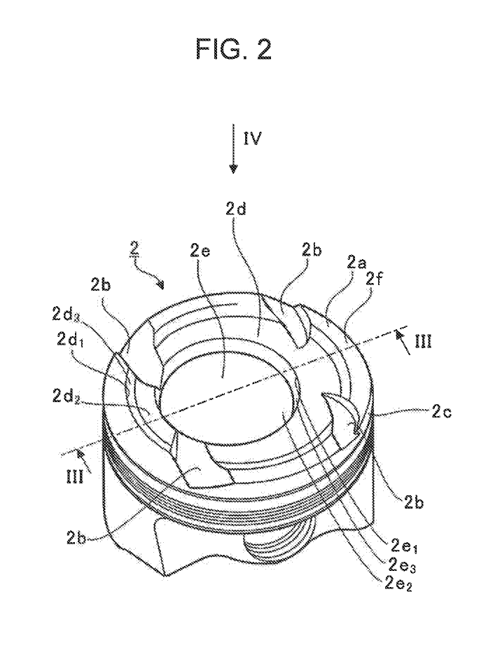

FIG. 2 is a perspective view of a crown surface 2a side of the piston 2. As illustrated in FIG. 2, a crown surface 2a has four recesses 2b. Each recess 2b extends from an outer peripheral surface 2c of the piston 2 to a radially inner side. The recesses 2b avoid interference of the piston 2 with the distal end of the intake valve 9 and the distal end of the exhaust valve 10 when the piston 2 is at the top dead center.

The piston 2 further has a first cavity 2d and a second cavity 2e. The first cavity 2d and the second cavity 2e are depressions formed in the crown surface 2a. The first cavity 2d and the second cavity 2e of the crown surface 2a of the piston 2, when viewed from the front (viewed from the cylinder head 4 side), are substantially circular.

The first cavity 2d in the crown surface 2a is more depressed (further separated from the cylinder head 4) than a top surface 2f which is located furthest toward the cylinder head 4 side, that is, nearest to the cylinder head 4, in the crown surface 2aFurthermore, the first cavity 2d is located further toward the radially inner side than the top surface 2f in the crown surface 2a. That is, the first cavity 2d is separated from the outer peripheral surface 2c of the piston 2. In the first cavity 2d, an outer periphery 2d₁ and a bottom surface 2d₂ are connected by a curved surface 2d₃.

The second cavity 2e is a depression that is formed inside the first cavity 2d and that is deeper than the first cavity 2d. The second cavity 2e is separated radially inward from the outer periphery 2d₁ of the first cavity 2d. Furthermore, similarly to the first cavity 2d, the second cavity 2e has an outer periphery 2e₁ and a bottom surface 2e₂ that are connected by a curved surface 2e₃.

Of the four recesses 2b, two recesses 2b (two recesses on the right in FIG. 2) extend from the outer peripheral surface 2c of the piston 2 into an interior of the first cavity 2d and are separated from the second cavity 2e. Of the four recesses 2b, the other two recesses 2b (the recesses on the left in FIG. 2) extend from the outer peripheral surface 2c of the piston 2 into an interior of the second cavity 2e through the interior of the first cavity 2d.

FIGS. 3A and 3B are diagrams for describing functions of the first cavity 2d and the second cavity 2e and are schematic sectional views of the engine 1 taken along a center axis of the piston 2, illustrating surroundings around the combustion chamber 6. Furthermore, the sectional views of the piston 2 shown in FIGS. 3A and 33 are taken along line in FIG. 2.

As indicated by arrows in FIG. 3A, intake gas that flows from the intake port 7 into the combustion chamber 6 during the intake stroke flows toward a lower right portion of the combustion chamber 6 (a portion at the exhaust port 8 side and the crown surface 2a side of the piston 2) in FIG. 3A. After that, the intake gas is guided along an exhaust port 8 side inner wall of the cylinder 5, flows along the crown surface 2a to the left side in FIG. 3A (to the intake port 7 side), and is guided along an intake port 7 side inner wall of the cylinder 5 and returns to the upper side (the cylinder head 4 side) in FIG. 3A. In this manner, in the engine 1, intake gas forms tumble flows.

As illustrated in FIG. 3A, the center of curvature of the curved surface 2d₃ of the first cavity 2d is located above the top surface 2f of the piston 2. The curved surface 2d₃ on the right side in FIG. 3A (on the exhaust port 8 side) functions as a guide that guides intake gas flowing downward to the right to the left side along the first cavity 2d. The curved surface 2d₃ on the left side in FIG. 3A (on the intake port 7 side) functions as a guide that guides intake gas flowing to the left side along the first cavity 2d to an upper side.

In this manner, the first cavity 2d functions as a guide that facilitates formation of tumble flow. In the engine 1, forming tumble flow realizes the rapid combustion of fuel caused by a strong turbulence produced when the tumble flow breaks, so that fuel economy and combustion stability can be improved.

As illustrated in FIG. 3B, the second cavity 2e is formed at a location that faces the injector 14. The center of curvature of a curved surface 2e₃ of the second cavity 2e is located above the bottom surface 2d₂ relative to the piston 2.

Fuel sprayed in, for instance, a conical shape (radial shape), from the injector 14 moves toward a bottom surface 2e₂ of the second cavity 2e and then is guided by the curved surface 2e; toward the ignition plug 13 provided next to the injector 14. Specifically, the second cavity 2e guides sprayed fuel to the ignition plug 13. Therefore, in the engine 1, a mixture having a high concentration of fuel is formed in the vicinity of the injector 14, for instance, during low load operation, so that it becomes possible to realize stratified lean burn.

As described above, the piston 2 is provided with the first cavity 2d that facilitates formation of tumble flow and the second cavity 2e that guides fuel to the ignition plug 13 are provided. However, when tumble flow enters the second cavity 2e, the incoming tumble flow reduces a flow speed, resulting in a non-uniform flow speed of the incoming tumble flow and the tumble flow not entering the second cavity 2e. This results in deteriorated quality of tumble flow. Therefore, the piston 2 is configured to stop tumble flow from entering the second cavity 2e.

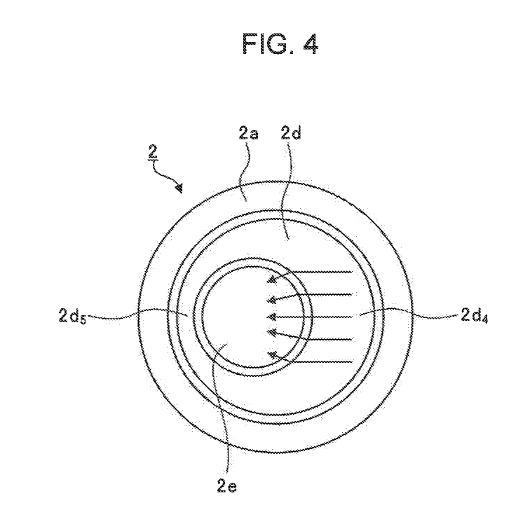

FIG. 4 is a front view of the crown surface 2a of the piston 2 viewed as indicated by an arrow IV in FIG. 2. FIG. 4 omits illustration of the recesses 2b in order to facilitate the understanding. In FIG. 4, arrows indicate tumble flow flowing along the crown surface 2a. As illustrated in FIG. 4, tumble flow moves along the crown surface 2a from the right side to the left side in FIG. 4 (from the exhaust port 8 side to the intake port 7 side).

A region in the first cavity 2d which is closer to the right side in FIG. 4 than the second cavity 2e will be referred to as “upstream portion 2d₄”. That is, the upstream portion 2d₄ is a region in the first cavity 2d which is closer to the exhaust port 8 side than the second cavity 2e. Furthermore, a region in the first cavity 2d which is closer to the left side in FIG. 4 than the second cavity 2e will be referred to as “downstream portion 2d₅”. That is, the downstream portion. 2d₅ is a region in the first cavity 2d which is closer to the intake port 7 side than the second cavity 2e.

The upstream portion 2d₄ extends further in the flow direction of tumble flow flowing along the crown surface 2a (in the left-right direction in FIG. 4) than the downstream portion 2d₅. In other words, while the first cavity 2d is provided substantially at the center of the crown surface 2a, the second cavity 2e is offset from the center of the crown surface 2a to the intake port 7 side.

FIGS. 5A and 5B are diagrams for describing the function resulting from the length of the upstream portion 2d₄. FIG. 5A illustrates the engine 1 of this example while FIG. 5B illustrates an engine E of a comparative example. As illustrated in FIG. 5B, the engine E of the comparative example has an upstream portion. Ea and a downstream portion Eb that have substantially equal lengths in the flow direction of tumble flow flowing on a crown surface Ec. In other words, in the engine E of the comparative example, both the first cavity Ed and the second cavity Ee are formed substantially at the center of the crown surface Ec.

In the engine E of the comparative example, although tumble flow flows along the upstream portion Ea, the length of the upstream portion Ea is insufficient, so that the tumble flow reaches the second cavity Ee before being sufficiently urged to flow leftward. Therefore, the tumble flow enters the second cavity Ee and reduces a flow speed.

In contrast, in the example of the invention, since the upstream portion 2d₄ is long as illustrated in FIG. 5A, tumble flow flowing along the upstream portion 2d₄ is sufficiently urged to flow leftward before reaching the second cavity 2e. Therefore, the tumble flow reaching the second cavity 2e has a high flow speed and therefore separates from the crown surface 2a, so that the tumble flow keeps flowing leftward without entering the second cavity 2e.

Because the tumble flow does not enter the second cavity 2e but keeps a distance from the second cavity 2e, the tumble flow is less subject to the viscosity of gas present in the vicinity of the bottom surface 2e₂ of the second cavity 2e, so that the slowing down of part of the tumble flow is avoided. Thus, the tumble flow can be inhibited from having a non-uniform flow speed and therefore can be inhibited from deteriorating in quality.

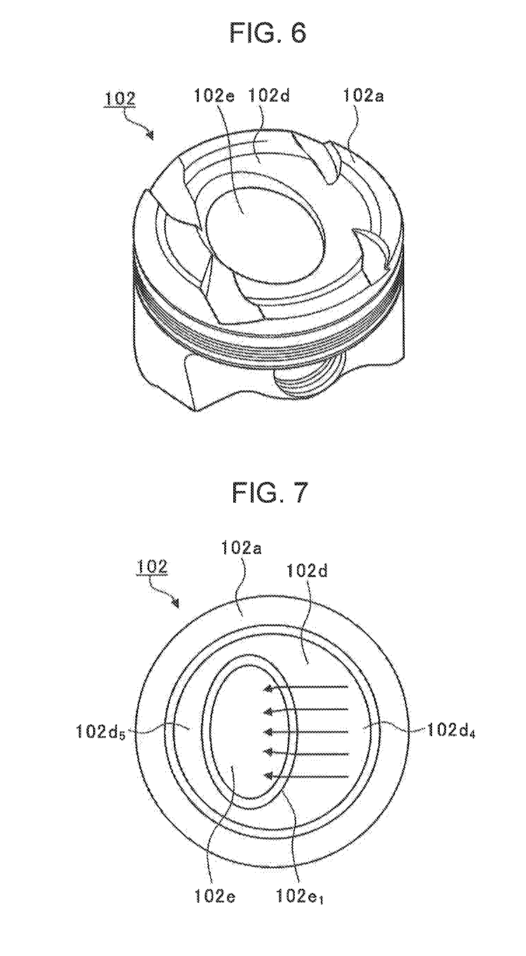

FIG. 6 is a perspective view of a crown surface 102a side of a piston 102 according to a modification. In the foregoing example, the first cavity 2d and the second cavity 2e of the crown surface 2a of the piston 2 are substantially circular when viewed from the front (viewed from the cylinder head 4 side). In this modification, as illustrated in FIG. 6, a first cavity 102d is substantially circular but a second cavity 102e is substantially elliptical.

FIG. 7 is a front view of the crown surface 102a of the piston 102 according to the modification. In FIG. 7, arrows indicate tumble flow flowing along the crown surface 102a. As illustrated in FIG. 7, in the modification, similar to the foregoing example, an upstream portion 102d₄ extends further in the flow direction of tumble flow moving along the crown surface 102a (the left-right direction in FIG. 7) than a downstream portion 102d₅.

Furthermore, the second cavity 102e has a substantially elliptical shape with its short axis lying in the flow direction of tumble flow (the left-right direction in FIG. 7). The long axis of the elliptical second cavity 102e is orthogonal to the flow direction of tumble flow.

In the case where the second cavity 102e is elliptical, the upstream portion 102d₄ can be reliably made longer than in the case where the second cavity 102e is circular provided that the second cavities 102e in the two cases are designed to have equal volumes. That is, when a second cavity 102e that is elliptical and a second cavity 102e that is circular of the crown surfaces 102a in these two cases have equal areas when viewed from the front, since the short axis of the elliptical second cavity 102e is shorter than the diameter of the circular second cavity 102e, a long upstream portion 102d₄ can be secured in the case where the circular second cavity 102e is provided. As a result, as in the foregoing example, tumble flow flowing along the upstream portion 102d₄ is sufficiently urged to flow leftward and then reaches the second cavity 102e, so that, due to its flow speed, the tumble flow separates from the crown surface 102a and does not enter the second cavity 102e. Hence, the tumble flow can be effectively inhibited from having a non-uniform flow speed and therefore can be inhibited from deteriorating in quality.

Furthermore, when tumble flow reaches the second cavity 102e and separates from the crown surface 102a, the tumble flow tends to turn to directions orthogonal to tangents to the outer periphery 102e₁ of the second cavity 102e. Specifically, as indicated by arrows in FIG. 7, tumble flows flowing near two ends of a long axis of the elliptical second cavity 102e (upper and lower ends of the long axis in FIG. 7) change their directions slightly toward the center of the elliptical second cavity 102e.

For instance, since the second cavity 102e is elliptical, the curvature of the outer periphery 102e₁, from which tumble flow separates, is larger than in the case where the second cavity 102e is circular (provided that the aforementioned areas of the second cavities 102e are equal). Therefore, tumble flows change their directions toward the center of the elliptical second cavity 102e only to a small degree. In consequence, tumble flow is not disturbed and therefore is inhibited from deteriorating in quality.

As described above, the example and the modification can inhibit tumble flow from having a non-uniform flow speed and therefore from deteriorating in quality due to the cavities that guide fuel to the ignition plug.

While the preferred examples of the present invention have been described with reference to the drawings, it is apparent that these examples and the like do not limit the present invention. It is apparent to a person having ordinary skill in the art that other various modifications and the like can be conceived within the scope of the invention described in the claims and it can be understood that such modifications are naturally included within the technical scope of the invention.

For instance, in the foregoing example and modification, tumble flow flows clockwise after moving downward to the right from the intake port 7 in FIG. 3A. However, tumble flow may flow counterclockwise in FIG. 3A. Specifically, tumble flow, after flowing from the intake port 7 to a lower side in FIG. 3A, may move to the right side and then move toward the exhaust port 8. In the case where tumble flow flows counterclockwise in FIG. 3A in this manner, an upstream portion 2d₄, 102d₄ is in a region in the first cavity 2d, 102d which is closer to the intake port 7 side than the second cavity 2e, 102e. A downstream portion 2d₅, 102d₅ is a region in the first cavity 2d, 102d which is closer to the exhaust port 8 side than the second cavity 2e, 102e.

The present invention can be used for internal combustion engine pistons whose crown surfaces have cavities.

1. A piston of an internal combustion engine, comprising:
a crown surface configured to form an internal wall surface of a combustion chamber;
a first cavity that is a depression provided in the crown surface; and
a second cavity that is a depression provided inside the first cavity, wherein
the first cavity includes an upstream portion located upstream of the second cavity in a flow direction of a tumble flow flowing along the crown surface and a downstream portion located downstream of the second cavity in the flow direction, the upstream portion extending further in the flow direction than the downstream portion.

2. The piston according to claim 1, wherein the second cavity has an elliptical shape whose short axis lies in the flow direction.

3. A piston of an internal combustion engine, comprising:
a crown surface configured to face a combustion chamber;
a first cavity that is a depression provided in the crown surface; and
a second cavity that is a depression provided in the first cavity and that has an elliptical shape whose short axis lies in a flow direction of a tumble flow flowing along the crown surface.
